(19) United States
(12) Patent Application Publication
(10) Pub. No.: US 2026/0228032 A1
(43) Pub. Date: Aug. 6, 2026

(54) Data Processing Method and Apparatus for WiFi Chip

(71) Applicant: Sanechips Technology Co., Ltd., Shenzhen (CN)

(72) Inventors: Yuchen LIU, Shenzhen (CN); Jilei FAN, Shenzhen (CN); Xiangxiang LI, Shenzhen (CN)

(21) Appl. No.: 19/149,907

(22) PCT Filed: Nov. 14, 2023
(86) PCT No.: PCT/CN2023/131623

§ 371 Date: Jul. 22, 2025

(30) Foreign Application Priority Data
Feb. 24, 2023 (CN) 202310215912.X

(51) Int. Cl. G06F 9/48

(52) U.S. Cl. CPC G06F 9/4812

(57) ABSTRACT

Provided in the embodiments of the present disclosure are a data processing method and apparatus for a WiFi chip. The method comprises: acquiring from a wired-side interface first data to be processed in a sending direction; carrying out first-stage data processing on said first data by means of a first central processing unit, thereby obtaining first data; when the first central processing unit triggers a first interruption, caching the first data to a data forwarding queue in the sending direction; and when a second central processing unit triggers a data forwarding interruption in the sending direction, extracting second data from the data forwarding queue, and carrying out second-stage data processing on the second data by means of the second central processing unit.

### CROSS-REFERENCE TO RELATED APPLICATION

The present disclosure is a national stage filing under 35 U.S.C. § 371 of international application number PCT/CN 2023/131623, filed Nov. 14, 2023, which is based on and claims priority to Chinese patent application CN 202310215912X filed on Feb. 24, 2023 and entitled “Data Processing Method and Apparatus for WiFi Chip”, the disclosures of which are incorporated herein by reference in their entirety.

### TECHNICAL FIELD

The present disclosure relates to the field of communications, and in particular to a data processing method and apparatus for a Wireless Fidelity (WiFi) chip.

### BACKGROUND

With rapid development of consumer electronics and smart products, performance requirements for WiFi as a current mainstream wireless transmission technology are continuously increasing. However, performance bottleneck of WiFi depends not only on throughput of a WiFi chip but also on capability of a Central Processing Unit (CPU) required to fully utilize performance of the WiFi chip. Currently, a multi-core processor is a mainstream way to enhance the performance of the CPU, and making good use of the multi-core characteristics of the CPU is key to fully leveraging the performance of the WiFi chip.

There are currently two main technologies used to balance the multi-core resources of the CPU. The first method is core binding, which involves binding interrupts of a WiFi driver and an Internal Direct Memory Access (IDM) driver to different cores. This allows data processing flows on the two drivers to be triggered by their respective interrupts and run on two different cores. Experimental verification has shown that for the same amount of data, the WiFi driver requires more CPU resources compared to the IDM driver. In a large data volume scenario, it is common for the core where the WiFi driver is running to be fully loaded, while the core where the IDM driver is running remains idle, leading to reduced WiFi performance and waste of CPU resources. The second method is a tasklet approach, which is a core splitting method provided by the Linux kernel. Although the tasklet approach can split a single driver flow, users need to write different tasklet initialization functions and processing functions for different WiFi chips, resulting in a higher implementation cost. Moreover, directly using the tasklet approach for core splitting will incur inter-core communication overhead, and excessive scheduling can further increase the CPU burden and affect performance.

In summary, there is still no good solution to the problem of CPU resource waste caused by a multi-core resource allocation method for a WiFi chip in the related technologies.

### SUMMARY

Embodiments of the present disclosure provide a data processing method and apparatus for a WiFi chip, which may at least solve the problem of CPU resource waste caused by a multi-core resource allocation method for a WiFi chip in the related technologies.

According to some embodiments of the present disclosure, a data processing method for a WiFi chip is provided. The data processing method includes: performing, through a first central processor, first-stage data processing on data to be processed, so as to obtain first data; in a case where the first central processor triggers a first interrupt, caching the first data to a data forwarding queue; and in a case where a second central processor triggers a data forwarding interrupt, extracting second data from the data forwarding queue, and performing second-stage data processing on the second data through the second central processor, wherein the second data is part or all of data in the first data.

According to another embodiment of the present disclosure, a data processing apparatus for a WiFi chip is provided. The data processing apparatus includes: a first processing module, configured to perform, through a first central processor, first-stage data processing on data to be processed, so as to obtain first data; a caching module, configured to cache the first data to a data forwarding queue, in a case where the first central processor triggers a first interrupt; and a second processing module, configured to, in a case where a second central processor triggers a data forwarding interrupt, extract second data from the data forwarding queue, and perform second-stage data processing on the second data through the second central processor, wherein the second data is part or all of data in the first data.

According to still another embodiment of the present disclosure, a computer-readable storage medium is also provided. The computer-readable storage medium stores a computer program, wherein the computer program, when running by a processor, causes the processor to execute the operations in any one of the foregoing method embodiments.

According to yet another embodiment of the present disclosure, an electronic device is also provided, including a memory and a processor, wherein the memory stores a computer program, and the processor is configured to run the computer program so as to execute the operations in any one of the method embodiments.

### BRIEF DESCRIPTION OF THE DRAWINGS

FIG. 1 is a block diagram showing the hardware structure for implementing a data processing method for a WiFi chip according to some embodiments of the present disclosure;

FIG. 2 is a flowchart of a data processing method for a WiFi chip according to some embodiments of the present disclosure;

FIG. 3 is a schematic diagram of an original data flow of a WiFi chip;

FIG. 4 is a schematic diagram of a data flow for a WiFi chip with a Wireless Forward Module (WFWD) according to some embodiments of the present disclosure;

FIG. 5 is a schematic diagram of a data flow for a WiFi chip according to some embodiments of the present disclosure;

FIG. 6 is a schematic diagram of a data flow for a WiFi chip in a reception direction according to some embodiments of the present disclosure;

FIG. 7 is a flowchart of initialization of a WFWD module according to some embodiments of the present disclosure;

FIG. 8 is a flowchart of data processing inside a WFWD module in a transport direction according to some embodiments of the present disclosure;

FIG. 9 is a flowchart of data processing inside a WFWD module in a reception direction according to some embodiments of the present disclosure; and

FIG. 10 is a block diagram of a data processing apparatus for a WiFi chip according to some embodiments of the present disclosure.

### DETAILED DESCRIPTION OF THE EMBODIMENTS

The embodiments of the present disclosure will be described below in detail with reference to the accompanying drawings and in conjunction with embodiments.

It should be noted that, terms such as “first” and “second” in the description, claims, and accompanying drawings of the present disclosure are used to distinguish similar objects, but are not necessarily used to describe a specific sequence or order.

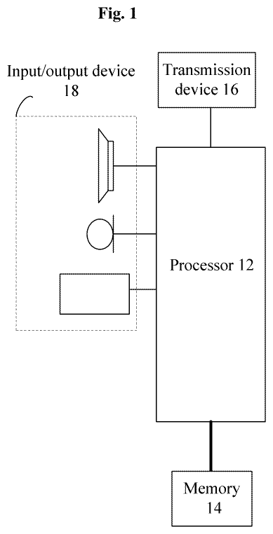

The method embodiments provided in the embodiments of the present disclosure may be executed in a mobile terminal, a computer terminal or a similar computing device. Taking the running on a computer terminal as an example, FIG. 1 is a block diagram showing the hardware structure for implementing a data processing method for a WiFi chip according to some embodiments of the present disclosure. As shown in FIG. 1, the hardware board may include one or more (only one is shown in FIG. 1) processors 12 (each of the one or more processors 12 may include, but is not limited to, a processing apparatus such as a microprocessor (MCU) or a programmable logic device) and a memory 14 configured to store data. The mobile terminal may further include a transmission device 16 for a communication function and an input/output device 18. Those having ordinary skill in the art may understand that the structure shown in FIG. 1 is merely exemplary, which does not limit the structure of the foregoing mobile terminal. For example, the mobile terminal may further include more or fewer components than shown in FIG. 1, or have a different configuration from that shown in FIG. 1.

The memory 14 may be used for storing a computer program, for example, a software program and a module of application software, such as a computer program corresponding to the data processing method for the WiFi chip in the embodiments of the present disclosure. The one or more processors 12 execute various functional applications and the data processing method for the WiFi chip by running the computer program stored in the memory 14, thereby implementing the described method. The memory 14 may include a high-speed random access memory, and may also include a non-volatile memory, such as one or more magnetic storage devices, flash memory, or other non-volatile solid-state memory. In some embodiments, the memory 14 may further include a memory that is remotely located with respect to the one or more processors 12, and the remote memory may be connected to the mobile terminal over a network. Examples of such networks include, but are not limited to, the Internet, intranets, local area networks, mobile communication networks, and combinations thereof.

The transmission device 16 is configured to receive or transmit data via a network. Specific examples of the described network may include a wireless network provided by a communication provider. In an example, the transmission device 16 includes a Network Interface Controller (NIC) that may be coupled to other network devices via a base station to communicate with the Internet. In an example, the transmission device 16 may be a Radio Frequency (RF) module for communicating wirelessly with the Internet.

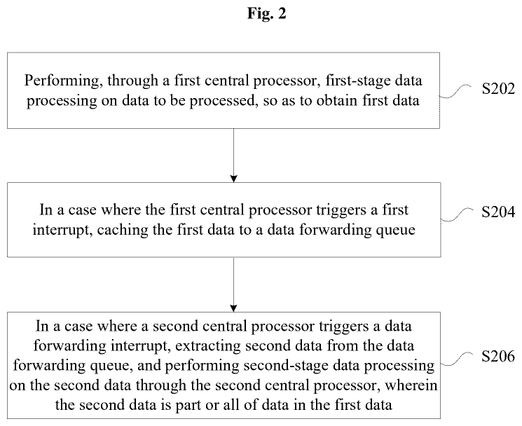

Provided in an embodiment of the present disclosure is a data processing method for a WiFi chip. FIG. 2 is a flowchart of a data processing method for a WiFi chip according to some embodiments of the present disclosure. As shown in FIG. 2, the flow includes the following operations S202 to S206.

In operation S202, first-stage data processing is performed on data to be processed through a first central processor, so as to obtain first data.

In operation S204, in a case where the first central processor triggers a first interrupt, the first data is cached to a data forwarding queue.

In operation S206, in a case where a second central processor triggers a data forwarding interrupt, second data is extracted from the data forwarding queue, and second-stage data processing is performed on the second data through the second central processor.

In the embodiments of the present disclosure, the second data in operation S206 is a part or all of the first data.

In an exemplary embodiment, after operation S202, the data processing method further includes an operation of triggering the first interrupt through the first central processor in a case where a number of data packets of the first data is equal to a first preset threshold; or, an operation of triggering the first interrupt through the first central processor in a case where an accumulated duration of acquiring the first data is equal to a second preset threshold.

Furthermore, by setting the first preset threshold and the second preset threshold, it is possible to prevent excessive data processing volume during peak periods, as well as to prevent excessively long data processing waiting times during off-peak periods.

In an embodiment, the operation of caching the first data to the data forwarding queue in operation S204 may specifically include the following operations S2042 and S2044.

In operation S2042, an enqueue interface of the data forwarding queue is invoked.

In operation S2044, a plurality of data packets in the first data are sequentially cached to the data forwarding queue through the enqueue interface.

In the embodiments of the present disclosure, operation S2044 may include sequentially performing the following operations on each data packet of the plurality of data packets in the first data: receiving the data packet through the enqueue interface; determining whether a total amount of data in the data forwarding queue is greater than or equal to a third preset threshold; in a case where the total amount of data in the data forwarding queue is greater than or equal to the third preset threshold, discarding the data packet; and in a case where the total amount of data in the data forwarding queue is not greater than or equal to the third preset threshold, inserting the data packet into a tail of the data forwarding queue.

Specifically, during a single caching process, if the data forwarding queue is full, then the remaining uncached data packets are discarded. The number (i.e., the third preset threshold) of data packets that the data forwarding queue can accommodate may be adjusted based on a size of a pre-applied memory space.

In an exemplary embodiment, after operation S2044, the data processing method further includes operations of invoking a dequeue interface of the data forwarding queue through the second central processor; and triggering the data forwarding interrupt through the second central processor in a case where there is at least one data packet in the data forwarding queue.

In the embodiments of the present disclosure, after the operation of triggering the data forwarding interrupt through the second central processor, the data processing method further includes: invoking, through the second central processor, an interrupt service function bound with the data forwarding interrupt; and invoking a tasklet function through the interrupt service function, wherein the tasklet function is put into a tasklet task queue, and is sequentially scheduled and executed by the second central processor.

Specifically, the tasklet function is put into the tasklet task queue, and is sequentially scheduled and executed by the second central processor.

In an embodiment, the operation of extracting the second data from the data forwarding queue, and performing the second-stage data processing on the second data through the second central processor in operation S206 may specifically include operations S2062 to S2066.

In operation S2062, all data packets in the data forwarding queue are sequentially extracted from a head of the data forwarding queue, so as to obtain the second data.

In operation S2064, a pre-encapsulated callback function is invoked through the second central processor.

In operation S2066, the second-stage data processing is performed on the second data through the pre-encapsulated callback function.

In an exemplary embodiment, the data to be processed in operation S202 may specifically include data in a transport direction that is acquired from a wired side interface and data in a reception direction that is acquired from a wireless side interface.

Further, the data forwarding queue includes a queue in the transport direction and a queue in the reception direction; each data forwarding queue corresponds to one enqueue interface and one dequeue interface respectively; the data forwarding queue is a lockable queue, and each data forwarding queue is able to invoke only one of the enqueue interface or the dequeue interface at the same time.

Specifically, using a lockable queue can prevent two processes from enqueuing or dequeuing simultaneously, which could cause data corruption.

In an embodiment, operation S202 may specifically include: in a case where the data to be processed is the data in the transport direction, transporting the data in the transport direction from the wired side interface to a WiFi driver through an Internal Direct Memory Access (IDM) driver.

Specifically, the wired side interface includes a Passive Optical Network (PON) interface, a Wide Area Network (WAN) interface or a Local Area Network (LAN) interface.

In another embodiment, operation S202 may specifically include: in a case where the data to be processed is the data in the reception direction, performing data processing on the data in the reception direction through closed-source software in the WiFi driver.

In an embodiment, the operation of performing the second-stage data processing on the second data through the second central processor in operation S206 may specifically include: in a case where the data to be processed is the data in the transport direction, performing data processing on the second data in the transport direction through open-source software in the WiFi driver, so as to obtain third data.

Further, after performing the data processing on the second data in the transport direction through the open-source software in the WiFi driver, so as to obtain the third data, the data processing method further includes: triggering a second interrupt through the first central processor; performing third-stage data processing on the third data through the first central processor, so as to obtain fourth data.

Specifically, the operation of performing the third-stage data processing on the third data includes performing data processing on the third data through closed-source software in the WiFi driver. sending the fourth data through the wireless side interface.

In another embodiment, the operation of performing the second-stage data processing on the second data through the second central processor in operation S206 may specifically include: in a case where the data to be processed is the data in the reception direction, performing data processing on the second data in the reception direction through open-source software in the WiFi driver, so as to obtain third data.

Further, after performing the data processing on the second data in the reception direction through the open-source software in the WiFi driver, so as to obtain the third data, the data processing method further includes: transporting the third data from the WiFi driver to the wired side interface through the IDM driver; and transporting the third data through the wired side interface.

In an exemplary embodiment, before operation S202, the data processing method further includes: during an initialization phase of the WiFi chip, pre-applying for a memory pool for the IDM driver and the WiFi driver.

Specifically, the memory pool stores data packets of the IDM driver or the WiFi driver in a memory space in a stack mode.

Further, the data processing method further includes: in a case where the IDM driver or the WiFi driver receives the data packet, popping a memory space corresponding to the data packet from a top of the memory pool, wherein the memory space is used for storing the data packet; in a case where the IDM driver or the WiFi driver releases the data packet, pushing a memory space corresponding to the data packet from the top of the memory pool.

In another exemplary embodiment, before operation S202, the data processing method further includes: during an initialization phase of the WiFi chip, binding the first interrupt and the second interrupt to the first central processor; and binding the data forwarding interrupt to the second central processor.

Furthermore, this embodiment is not limited to dual-core CPUs and the aforementioned interrupts. This embodiment can also be applied to other multi-core CPUs, by triggering interrupts to divide the complete data processing procedure into an arbitrary number of stages, and then processing the data packets separately in multiple cores through data forwarding interrupts.

In the embodiments of the present disclosure, by executing operations S202 to S206 as described above, the problem of CPU resource waste caused by a multi-core resource allocation method for a WiFi chip in the related technologies can be resolved. By triggering interrupts to break down the data processing procedure of the WiFi chip, multiple processing cores are enabled to execute segments of the data processing procedure respectively, thereby balancing CPU resources and simplifying the difficulty for users to implement multi-core optimization.

In another embodiment, the data forwarding queue described in the above embodiments may be encapsulated as a closed-source Wireless Forward Module (WFWD).

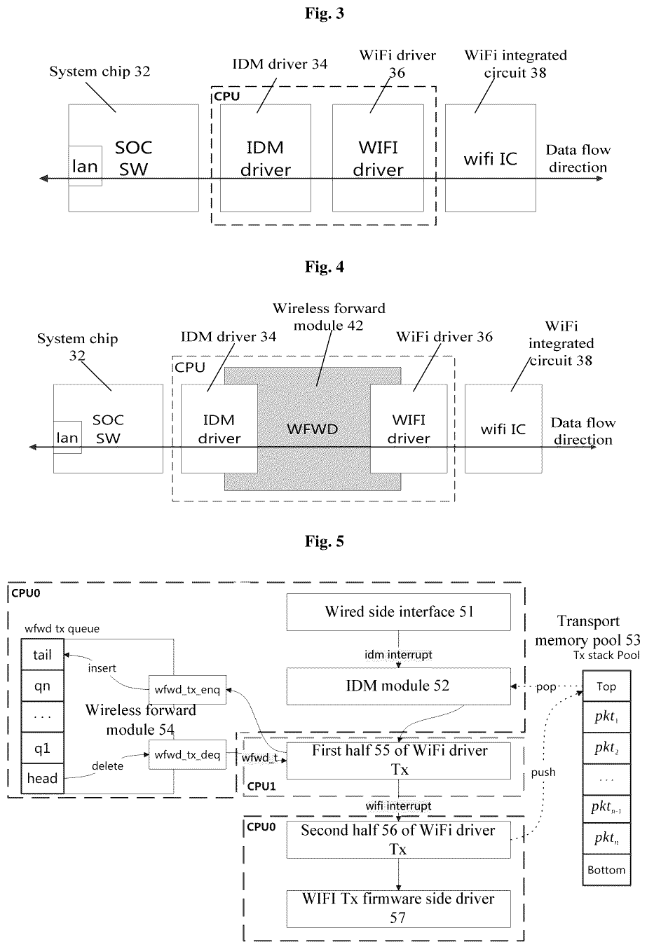

FIG. 3 is a schematic diagram of an original data flow of a WiFi chip. As shown in FIG. 3, in a case where a WiFi chip does not have a WFWD module, the original data flow needs to be implemented through a structure including the following components:
a system chip 32, an IDM driver 34, a WiFi driver 36, and a WiFi integrated circuit 38.

In this embodiment, data in the transport direction flows from a wired side interface (lan) into a wired part of a Switch (SW) of the system chip 32, then is forwarded to the WiFi driver 36 through the IDM driver 34, and finally, the WiFi driver 36 transports the data to the WiFi integrated circuit 38 (Integrated Circuit, abbreviated as IC).

Furthermore, the same is true when the data flow is in the reverse direction (i.e., reception direction).

In this embodiment, both the IDM driver 34 and the WiFi driver 36 rely on CPU processing.

FIG. 4 is a schematic diagram of a data flow for a WiFi chip with a Wireless Forward Module (WFWD) according to some embodiments of the present disclosure. As shown in FIG. 4, the data flow with a WFWD module is implemented through a structure including the following components:
a system chip 32, an IDM driver 34, a wireless forward module 42, a WiFi driver 36, and a WiFi integrated circuit 38.

Specifically, the data flow with the WFWD module is performed relying on a wireless forward module 42 (WFWD module) added between the original data flow's IDM driver 34 and WiFi driver 36. The wireless forward module 42 achieves uniform core distribution by breaking down the original data flow.

In this embodiment, the WFWD module only needs to expose two interfaces for WiFi data flow drivers from any manufacturer, which are an enqueue interface and a dequeue interface for triggering interrupts. Users only need to invoke the enqueue interface of the WFWD module at an appropriate position, break down the original data flow of the WiFi driver, fill all valid data into the queue of the WFWD module, then trigger a WFWD module interrupt on another core, and subsequently invoke the dequeue interface, to retrieve valid data and process the latter half of the data processing flow on this other core.

In this an embodiment of the present disclosure, the WiFi chip used may be MTK7916, which includes a multi-core CPU, an IDM module, a WFWD module, a Tx/Rx stack Pool (transport/reception resource pool), and a WiFi Tx/Rx (transport/reception) driver.

Furthermore, the CPU model of this chip is ZTE 128s, which includes two processor cores, CPU0 and CPU1, with the CPU integrating an interrupt controller for scheduling the IDM module, the WFWD module, the WiFi driver, and other interrupts of the system.

FIG. 5 is a schematic diagram of a data flow for a WiFi chip in a transport direction according to some embodiments of the present disclosure. As shown in FIG. 5, the data flow in the transport direction of the WiFi data is implemented through a structure including the following components:
a wired side interface 51, an Internal Direct Memory Access (IDM) module 52, a transport memory pool (Tx stack Pool) 53, a wireless forward module (WFWD) 54, a first half 55 of WiFi driver transport, a second half 56 of WiFi driver transport, and a WiFi firmware side driver 57.

In this embodiment, the wired side interface 51 may include a Passive Optical Network (PON) interface, a Wide Area Network (WAN) interface, or a Local Area Network (LAN) interface. Specifically, PON/WAN/LAN is the starting point for a wireless terminal device to send packets.

In this embodiment, the Internal Direct Memory Access (IDM) module 52 is an internal submodule in the CPU, and is capable of substituting the CPU to complete the data transfer between the WiFi driver and the PON/WAN/LAN driver, thereby reducing the CPU load.

In this embodiment, the transport memory pool 53 (Tx stack Pool) is a memory pool implemented in a memory space in a stack manner.

Specifically, the transport memory pool 53 needs to be pre-applied (pre-allocated) during the initialization phase of the IDM/WiFi drivers, and is responsible for allocating memory space for packets received by the IDM/WiFi drivers, as well as recycling memory space of packets released by the WiFi/IDM drivers. A segment of memory space is popped from the Top when the memory is allocated, and a segment of memory space is pushed from the Top when the memory is recycled.

In this embodiment, the wireless forward module (WFWD) 54 can store data sent by the IDM or WiFi drivers into a queue, and then retrieve data from the queue by triggering interrupts, to proceed with the next operation of data flow processing on a designated CPU core.

Specifically, the WFWD module provides two interfaces for the WiFi driver's Tx (transport) process, namely an enqueue interface wfwd_tx_enq and a dequeue interface wfwd_tx_deq.

Furthermore, the WFWD module has pre-applied for two interrupts for transport and reception, with the transport direction data forwarding interrupt wfwd_t on the Tx process, which, after being triggered, calls the dequeue interface wfwd_tx_deq to retrieve data from the queue and then switches to another core to handle the next operation of the data flow process.

In this embodiment, the queue of the WFWD module on the transport direction is the transport direction queue wfwd_tx_queue, where each valid element in the queue points to the address space of valid data packets stored in the transport memory pool 53 (Tx stack Pool), a packet is inserted at the tail of the queue when the packet is received, and a packet is removed from the head of the queue when this packet is sent.

In this embodiment, both the first half 55 of WiFi driver transport and the second half 56 of WiFi driver transport belong to the WiFi Tx (transport) driver, are open-source Software Development Kit (SDK) provided by the WiFi chip manufacturer, and are used for processing data packets and protocol packets received by the WiFi chip from the system or the air interface.

In this embodiment, the WiFi firmware side driver 57 is a closed-source SDK provided by the WiFi chip manufacturer, and is used to work in conjunction with the open-source part of the WiFi Tx driver to process data packets and protocol packets received by the WiFi chip from the system or the air interface.

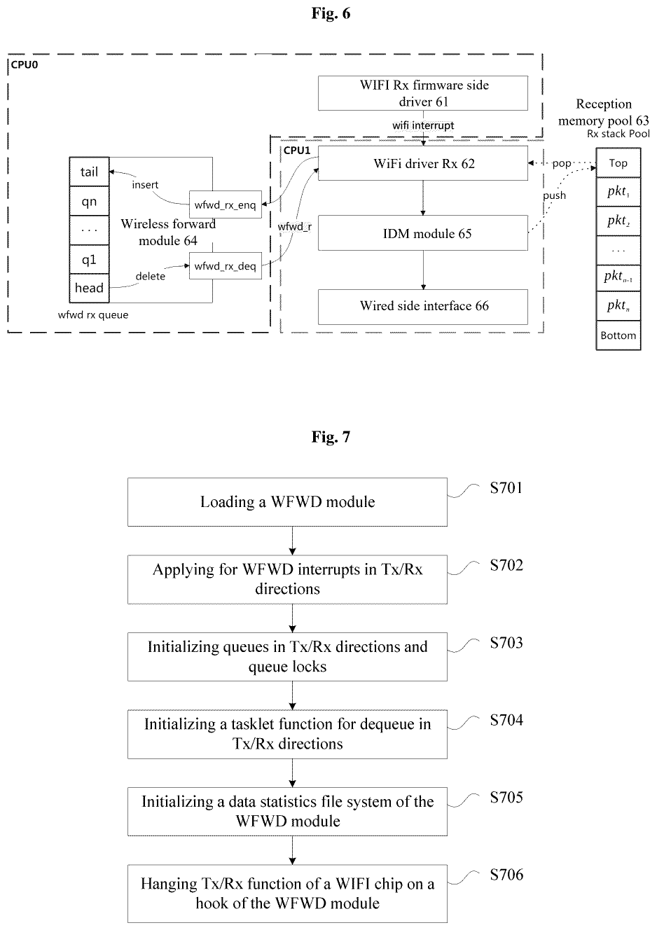

FIG. 6 is a schematic diagram of a data flow for a WiFi chip in a reception direction according to some embodiments of the present disclosure. As shown in FIG. 6, the data flow in the WiFi reception direction is implemented through a structure including the following components:
a WiFi reception firmware side driver 61, a WiFi driver reception 62, a reception memory pool (Rx stack Pool) 63, a wireless forward module 64, an Internal Direct Memory Access (IDM) module 65, and a wired side interface 66.

In this embodiment, the WiFi reception firmware side driver 61 is a closed-source SDK provided by the WiFi chip manufacturer, and is used in conjunction with the open-source part of the WiFi Rx driver to process data packets and protocol packets received by the WiFi chip from the system or the air interface.

In this embodiment, the WiFi driver reception 62 (WiFi Rx driver) is an open-source SDK provided by the WiFi chip manufacturer, and is used to process data packets and protocol packets received by the WiFi chip from the system or the air interface.

In this embodiment, the reception memory pool 63 (Rx stack Pool) is a memory pool implemented in a memory space in a stack manner.

Specifically, the reception memory pool 63 needs to be pre-applied (pre-allocated) during the initialization phase of the IDM/WiFi drivers, and is responsible for allocating a memory space for packets received by the IDM/WiFi drivers, as well as recycling the memory space of packets released by the WiFi/IDM drivers. A segment of memory space is popped from the top when a memory is allocated, and a segment of memory space is pushed from the top when a memory is recycled.

In this embodiment, the wireless forward module 64 (i.e., WFWD) can store data sent by the IDM or WiFi drivers into a queue, and then retrieve data from the queue by triggering interrupts, to proceed with the next operation of data flow processing on a designated CPU core.

Specifically, the WFWD module provides two interfaces for the WIFI driver Rx (reception) process, namely an enqueue interface wfwd_rx_enq and a dequeue interface wfwd_rx_deq.

Furthermore, the WFWD module has pre-applied for two interrupts for transport and reception, with the reception direction data forwarding interrupt wfwd_r on the Rx process, which, after being triggered, calls the dequeue interface wfwd_rx_deq to retrieve data from the queue, and then switches to another core to handle the next operation of the data flow process.

In this embodiment, the queue of the WFWD module on the transport direction is the transport direction queue wfwd_tx_queue, where each valid element in the queue points to the address space of valid data packets stored in the reception memory pool 63 (Rx stack Pool). A packet is inserted at the tail of the queue when this packet is received, and a packet is removed from the head of the queue when this packet is sent.

In this embodiment, the Internal Direct Memory Access module 65 (i.e., IDM) is a submodule inside the CPU, and is capable of substituting the CPU to complete the data transfer between the WiFi driver and the PON/WAN/LAN driver, thereby reducing the CPU load.

In this embodiment, the wired side interface 66 specifically includes a Passive Optical Network (PON) interface, a Wide Area Network (WAN) interface, or a Local Area Network (LAN) interface. Similarly, PON/WAN/LAN is the end point for a wireless terminal device to receive packets.

Through the embodiments of the present disclosure, it is only necessary to embed the enqueue interface and the dequeue interface of the WFWD module into the original data transport process of the WiFi driver, so as to divide the data flow process of the WiFi driver to be processed on different cores, thereby playing a role in balancing the CPU load. This method can also quickly adapt the multi-core optimization method implemented by the WFWD module to other models of WiFi chips, simplifying the difficulty for users to implement multi-core optimization, and has a high degree of versatility.

FIG. 7 is a flowchart of initialization of a WFWD module according to some embodiments of the present disclosure. As shown in FIG. 7, the initialization process of the WFWD module includes the following operations S701 to S706.

In operation S701, a WFWD module is loaded.

In operation S702, apply for WFWD interrupts in a transport/reception direction.

In operation S703, queues in the transport/reception direction and corresponding queue locks are initialized.

In operation S704, tasklet functions for dequeuing in the transport/reception direction are initialized.

In operation S705, a data statistics file system of the WFWD module is initialized.

In operation S706, the WiFi chip's transport/reception functions are hooked to the WFWD module's hooks.

In this embodiment, the WFWD module may be loaded during the initialization (boot) process of the Linux system.

In this embodiment, after the WFWD module is loaded, the WFWD module first applies to the Linux system for interrupt resources in the transport (Transport, referred to as Tx) and reception (Receive, referred to as Rx) directions, namely wfwd_t and wfwd_r. After the application is successful, the two interrupts obtained are bound to CPU1.

Furthermore, the interrupts of the WiFi driver and the IDM driver are on CPU0, and by binding the wfwd_t and wfwd_r interrupts to different cores, core splitting can be achieved.

In this embodiment, operation S703 initializes the WFWD module's transport direction queue wfwd_tx_queue and reception direction queue wfwd_rx_queue, as well as the locks that protect these two queues. The locks are used to prevent two processes from enqueuing or dequeuing at the same time, which could cause data corruption.

In this embodiment, operation S704 initializes the tasklet processing functions for the WFWD module's transport and reception directions.

The tasklet processing functions are not scheduled from CPU0 to CPU1, but follow the interrupts. The tasklet runs on the corresponding core where the interrupt is triggered. Since wfwd_t and wfwd_r have been initialized on CPU1, inter-core communication overhead is avoided.

In this embodiment, the data statistics file system in operation S705 is used to record the model of the WiFi chip during system loading and to perform statistics on packet transport and reception when the module is running.

In this embodiment, operation S706 may hook the callback functions for packet transport and reception of different WiFi chips to the WFWD module's hook functions.

Specifically, the callback function is the function that the WiFi driver is about to process next, which is broken down by the WFWD module's enqueue function, encapsulated as a callback function, and provided for calling when the WFWD module dequeues.

In this embodiment, the operations S701 to S705 are general initialization operations for different WiFi chips, and operation S706 is used to adapt to different models of WiFi chips. The timing of interrupt triggering and the content of the corresponding callback functions can also be further adjusted according to the number of cores.

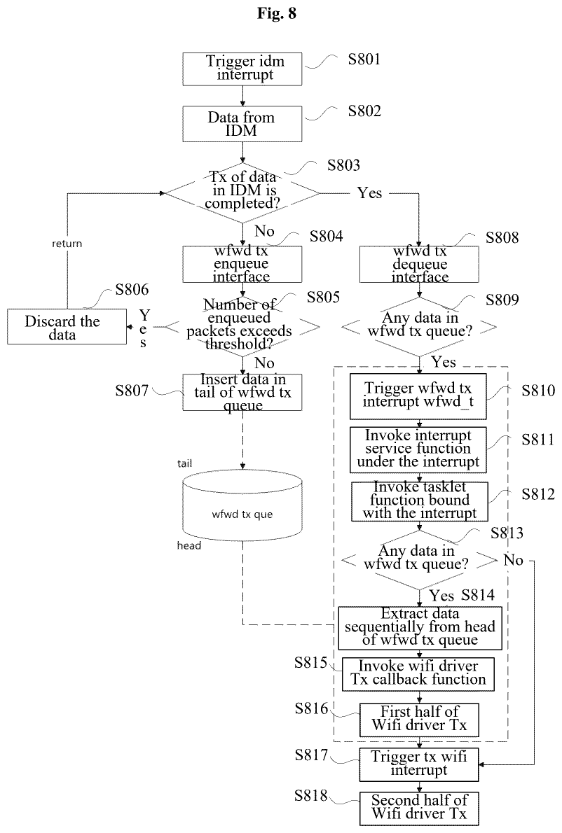

FIG. 8 is a flowchart of data processing inside a WFWD module in a transport direction according to some embodiments of the present disclosure. As shown in FIG. 8, the internal data processing flow of the WFWD module in the transport direction may specifically include the following operations S801 to S818.

In operation S801, an IDM interrupt is triggered.

In operation S802, data sent by an IDM chip is received.

In operation S803, it is determined whether the data in the IDM has been sent completely.

In operation S804, wfwd tx enqueue interface.

In operation S805, it is determined whether the number of the packets that have been enqueued exceeds a threshold value.

In operation S806, the data is discarded.

In operation S807, the data is inserted into the tail of the wfwd tx queue.

In operation S808, wfwd tx dequeue interface.

In operation S809, it is determined whether there is data in the wfwd tx queue.

In operation S810, wfwd tx interrupt wfwd_t is triggered.

In operation S811, an interrupt service function hooked under the interrupt is invoked (called).

In operation S812, a tasklet function bound with the interrupt is invoked.

In operation S813, it is determined whether there is data in the wfwd tx queue.

In operation S814, data is extracted sequentially from the header of the wfwd tx queue.

In operation S815, a WiFi driver Tx callback function is invoked.

In operation S816, first half of WiFi driver Tx.

In operation S817, tx WiFi interrupt is triggered.

In operation S818, second half of WiFi driver Tx.

In this embodiment, the flow within the dashed box in FIG. 8 is executed by CPU1, and other flows are executed by CPU0.

In this embodiment, after receiving a certain amount of data, the IDM triggers an interrupt to send a certain amount of data (for example, 256 data packets) to the WFWD module in a cyclic manner, the IDM interrupt is triggered on CPU0, and if there is no other interrupt triggered, the subsequent data processing flow remains to be performed on CPU0.

In this embodiment, the WFWD module invokes the enqueue interface to sequentially receive all the data packets sent from the IDM and stores these data packets in the wfwd tx queue.

In this embodiment, if the determination result in operation S803 is negative, operation S804 is executed, and if the determination result in operation S803 is positive, operation S808 is executed.

In this embodiment, operation S805 determines whether the number of data packets in the wfwd tx queue exceeds a threshold (e.g., 20480), if so, the data packet is discarded (operation S806), and if not, the data packet is sequentially inserted into the tail of the wfwd tx queue (operation S807).

In this embodiment, after IDM completes sending data in one interrupt, the IDM immediately triggers the wfwd tx dequeue interface.

In this embodiment, it is determined whether there is data in the wfwd tx queue; if there is data, the wfwd_t interrupt is triggered, and if not, no action is performed.

Furthermore, when there is data in the wfwd tx queue and the wfwd_t interrupt is successfully triggered, the interrupt service function bound to the wfwd_t interrupt is invoked; if this interrupt is triggered by CPU1, then the interrupt service function will also run on CPU1, thus achieving core splitting.

In this embodiment, the interrupt service function invokes the tasklet processing function, hanging the task to the Linux system's tasklet task queue, which is sequentially scheduled and executed by CPU1.

In this embodiment, data in the wfwd tx queue is extracted based on the number of data items in the wfwd tx queue, and the WiFi driver's Tx direction callback function is invoked.

Furthermore, the first half of WIFI driver Tx is completed within the callback function.

Specifically, in this embodiment, the first half of the WIFI driver may complete the descriptor filling operation according to the requirements of the MTK7916 WIFI driver; after this operation is completed, the WIFI driver itself will actively trigger the tx wifi interrupt, thereby completing the second half of the WIFI driver Tx.

In this embodiment, the tx wifi interrupt runs on CPU0, so the second half of the WIFI driver also runs on CPU0.

Furthermore, after the second half of the WIFI driver Tx is completed, the flow automatically proceeds to the WIFI Tx firmware side driver procedure, in which the data packets are sent into the air via the WiFi chip.

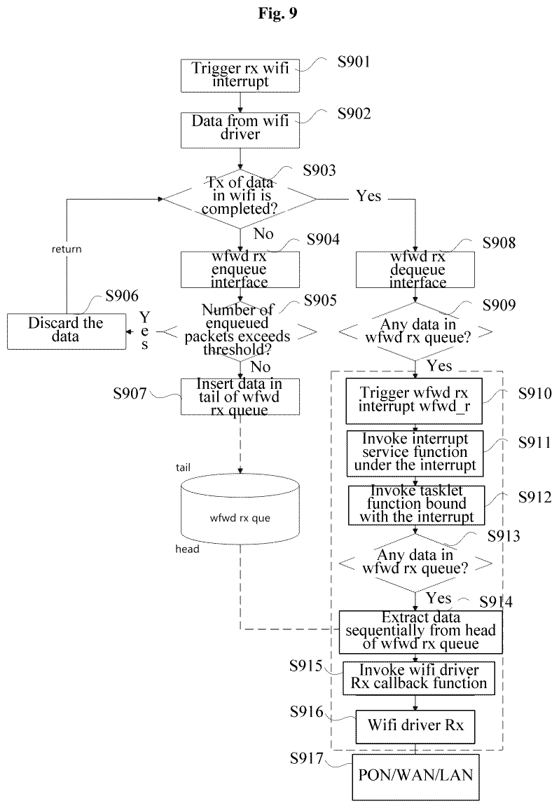

FIG. 9 is a flowchart of data processing inside a WFWD module in a reception direction according to some embodiments of the present disclosure. As shown in FIG. 9, the data processing flow within the WFWD module in the reception direction may specifically include the following operations S901 to S917.

In operation S901, a rx wifi interrupt is triggered.

In operation S902, data sent by the WiFi driver is received.

In operation S903, it is determined whether the transport of the data in the WiFi driver has been completed.

In operation S904, wfwd rx enqueue interface.

In operation S905, it is determined whether the number of packets already enqueued exceeds a threshold.

In operation S906, the data is discarded.

In operation S907, the data is inserted into the tail of the wfwd rx queue.

In operation S908, wfwd rx dequeue interface.

In operation S909, it is determined whether there is data in the wfwd rx queue.

In operation S910, a wfwd rx interrupt wfwd_r is triggered.

In operation S911, an interrupt service function registered with that interrupt is invoked.

In operation S912, a tasklet function bound to that interrupt is invoked.

In operation S913, it is determined whether there is data in the wfwd rx queue.

In operation S914, data is sequentially extracted from the head of the wfwd rx queue.

In operation S915, a WiFi driver Rx callback function is invoked.

In operation S916, WiFi driver Rx.

In operation S917, PON/WAN/LAN.

In this embodiment, after the WiFi chip receives a certain number of data packets, the firmware side of the WiFi driver triggers a data interrupt in the Rx direction to invoke the WiFi driver's tasklet function, sends data packets to the WFWD module in a cyclic manner. The WiFi driver Rx direction data interrupt is triggered on CPU0. If no other interrupts are triggered, the subsequent data processing flow remains on CPU0 for execution.

In this embodiment, the WFWD module invokes the enqueue interface to sequentially receive all data packets sent by the firmware side of the WIFI driver Rx direction and stores the data packets in the wfwd rx queue.

In this embodiment, whether the wfwd rx queue exceeds the threshold (for example, 20480) is determined in operation S905. If so, the data is discarded (operation S906); and if not, the data is inserted sequentially into the tail of the wfwd rx queue (operation S907).

In this embodiment, after the firmware side of the WIFI driver Rx direction completes sending data in one interrupt, the firmware side of the WIFI driver Rx direction triggers the wfwd rx dequeue interface.

In this embodiment, whether there is data in the wfwd rx queue is determined in operation S909. If there is, the wfwd_r interrupt is triggered (S910); and if not, no action is performed.

In this embodiment, when there is data in the wfwd rx queue and the wfwd_r interrupt is successfully triggered, the interrupt service function bound to the wfwd_r interrupt is invoked. This interrupt is triggered by CPU1, and the interrupt service function also runs on CPU1, thus achieving core splitting.

In this embodiment, the interrupt service function invokes the tasklet processing function, hanging the task to the Linux system's tasklet task queue, which is sequentially scheduled and executed by CPU1.

In this embodiment, in operation S914, data is sequentially extracted from the queue based on the number of data items in the wfwd rx queue, and the WIFI driver Rx direction callback function is invoked. Specifically, the second half of the WIFI driver Rx can be completed within the callback function.

Specifically, in this embodiment, the first half of the WIFI driver Rx mainly handles the interrupt response in the Rx direction of the MTK7916 WIFI driver and schedules the tasklet function triggered by the interrupt. After this operation is completed, the WIFI driver itself will actively trigger the rx wifi interrupt, thereby triggering the second half of the WIFI driver Rx process.

In this embodiment, IDM receives data packets on the Rx direction of the WiFi and, without the need for interrupt triggering, forwards the data packets directly to PON/WAN/LAN after processing by IDM. Therefore, the processing flow of the IDM driver also runs on CPU1, following the wfwd_r interrupt.

According to another aspect of the embodiments of the present disclosure, a data processing apparatus for a WiFi chip is further provided.

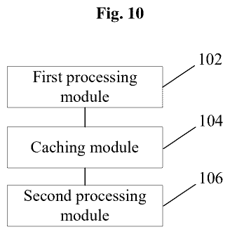

FIG. 10 is a block diagram of a data processing apparatus for a WiFi chip according to some embodiments of the present disclosure. As shown in FIG. 10, the data processing apparatus includes:
a first processing module 102, configured to perform, through a first central processor, first-stage data processing on data to be processed, so as to obtain first data;
a caching module 104, configured to cache the first data to a data forwarding queue, in a case where the first central processor triggers a first interrupt; and
a second processing module 106, configured to, in a case where a second central processor triggers a data forwarding interrupt, extract second data from the data forwarding queue, and perform second-stage data processing on the second data through the second central processor, wherein the second data is part or all of data in the first data.

In the embodiments of the present disclosure, the data processing apparatus further includes:
a first triggering module, configured to trigger the first interrupt through the first central processor in a case where a number of data packets of the first data is equal to a first preset threshold; or, trigger the first interrupt through the first central processor in a case where an accumulated duration of acquiring the first data is equal to a second preset threshold.

In the embodiments of the present disclosure, the caching module 104 may specifically include:
a first invoking unit, configured to invoke an enqueue interface of the data forwarding queue; and
a caching unit, configured to sequentially cache a plurality of data packets in the first data to the data forwarding queue through the enqueue interface.

In the embodiments of the present disclosure, the caching unit is further configured to sequentially perform following operations on each data packet of the plurality of data packets in the first data: receiving the data packet through the enqueue interface; determining whether a total amount of data in the data forwarding queue is greater than or equal to a third preset threshold; in a case where the total amount of data in the data forwarding queue is greater than or equal to the third preset threshold, discarding the data packet; and in a case where the total amount of data in the data forwarding queue is not greater than or equal to the third preset threshold, inserting the data packet into a tail of the data forwarding queue.

In the embodiments of the present disclosure, the data processing apparatus further includes:
a second triggering module, configured to invoke a dequeue interface of the data forwarding queue through the second central processor; and trigger the data forwarding interrupt through the second central processor in a case where there is at least one data packet in the data forwarding queue.

In the embodiments of the present disclosure, the data processing apparatus further includes an invoking module.

The invoking module is configured to invoke, through the second central processor, an interrupt service function bound with the data forwarding interrupt; and invoke a tasklet function through the interrupt service function, wherein the tasklet function is put into a tasklet task queue, and is sequentially scheduled and executed by the second central processor.

In the embodiments of the present disclosure, the second processing module 106 may specifically include:
an extracting unit, configured to sequentially extract all data packets in the data forwarding queue from a head of the data forwarding queue, so as to obtain the second data; and
a second invoking unit, configured to invoke a pre-encapsulated callback function through the second central processor; and
a processing unit, configured to perform the second-stage data processing on the second data through the pre-encapsulated callback function.

In the present embodiment, the first processing module 102 is configured to, in a case where the data to be processed is the data in the transport direction, transport the data in the transport direction from the wired side interface to a WiFi driver through an Internal Direct Memory Access (IDM) driver, wherein the wired side interface includes a Passive Optical Network (PON) interface, a Wide Area Network (WAN) interface or a Local Area Network (LAN) interface; or, in a case where the data to be processed is the data in the reception direction, perform data processing on the data in the reception direction through closed-source software in the WiFi driver.

In the embodiments of the present disclosure, the second processing module 106 is further configured to, in a case where the data to be processed is the data in the transport direction, perform data processing on the second data in the transport direction through open-source software in the WiFi driver, so as to obtain third data; or, in a case where the data to be processed is the data in the reception direction, perform data processing on the second data in the reception direction through open-source software in the WiFi driver, so as to obtain third data.

In an exemplary embodiment, the data processing apparatus may further include a third processing module.

The third processing module is configured to trigger a second interrupt through the first central processor; perform third-stage data processing on the third data through the first central processor, so as to obtain fourth data, wherein performing the third-stage data processing on the third data includes: performing data processing on the third data through closed-source software in the WiFi driver; and transport the fourth data through the wireless side interface.

In another exemplary embodiment, the third processing module is further configured to, after performing the data processing on the second data in the reception direction through the open-source software in the WiFi driver, so as to obtain the third data, transport the third data from the WiFi driver to the wired side interface through the IDM driver; and transport the third data through the wired side interface.

In an embodiment, the data processing apparatus further includes a memory module.

The memory module is configured to, during an initialization phase of the WiFi chip, pre-apply for a memory pool for the IDM driver and the WiFi driver, wherein the memory pool stores data packets of the IDM driver or the WiFi driver in a memory space in a stack mode.

The memory module is further configured to in a case where the IDM driver or the WiFi driver receives the data packet, pop a memory space corresponding to the data packet from a top of the memory pool, wherein the memory space is used for storing the data packet; in a case where the IDM driver or the WiFi driver releases the data packet, push a memory space corresponding to the data packet from the top of the memory pool.

In an embodiment, the data processing apparatus further includes an initialization module configured to, during an initialization phase of the WiFi chip, bind the first interrupt and the second interrupt to the first central processor; and bind the data forwarding interrupt to the second central processor.

The embodiments of the present disclosure further provide a computer-readable storage medium. The computer-readable storage medium stores a computer program. When being run by a processor, the computer program executes operations in any one of the foregoing method embodiments.

In an exemplary embodiment, the computer-readable storage medium may include, but is not limited to, any medium that can store a computer program, such as a USB flash drive, a Read-Only Memory (ROM), a Random Access Memory (RAM), a removable hard disk, a magnetic disk, or an optical disc.

The embodiments of the present disclosure further provide an electronic device, including a memory and a processor. The memory stores a computer program. The processor is configured to run the computer program to execute operations in any one of the method embodiments.

In an exemplary embodiment, the electronic device may further include a transmission device and an input/output device, wherein the transmission device is connected to the processor, and the input/output device is connected to the processor.

For exemplary embodiments in the embodiments of the present disclosure, reference may be made to the embodiments described in the foregoing embodiments and exemplary embodiments, and details are not repeatedly described in the embodiments of the present disclosure.

Obviously, those having ordinary skill in the art should understand that each module or each operation of the present disclosure can be implemented by a universal computing device, they may be centralized on a single computing device or distributed on a network composed of a plurality of computing devices, they can be implemented by program codes executable by a computing apparatus, and thus can be stored in a storage apparatus and executed by the computing apparatus. Furthermore, in some cases, the shown or described operations may be executed in an order different from that described here, or they are made into integrated circuit modules respectively, or a plurality of modules or operations therein are made into a single integrated circuit module for implementation. As such, the present disclosure is not limited to any particular hardware and software combination.

The foregoing descriptions are merely exemplary embodiments of the present disclosure, but are not intended to limit the present disclosure. For those having ordinary skill in the art, the present disclosure may have various modifications and variations. Any modifications, equivalent replacements, improvements and the like made within the principle of the present disclosure shall fall within the scope of protection of the present disclosure.

1. A data processing method for a Wireless Fidelity (WiFi) chip, wherein the data processing method comprises:
performing, through a first central processor, first-stage data processing on data to be processed, so as to obtain first data;
in a case where the first central processor triggers a first interrupt, caching the first data to a data forwarding queue; and
in a case where a second central processor triggers a data forwarding interrupt, extracting second data from the data forwarding queue, and performing second-stage data processing on the second data through the second central processor, wherein the second data is part or all of data in the first data.

2. The data processing method according to claim 1, wherein after performing, through the first central processor, the first-stage data processing on the data to be processed, so as to obtain the first data, the data processing method further comprises:
triggering the first interrupt through the first central processor in a case where a number of data packets of the first data is equal to a first preset threshold; or,
triggering the first interrupt through the first central processor in a case where an accumulated duration of acquiring the first data is equal to a second preset threshold.

3. The data processing method according to claim 1, wherein caching the first data to the data forwarding queue comprises:
invoking an enqueue interface of the data forwarding queue; and
sequentially caching a plurality of data packets in the first data to the data forwarding queue through the enqueue interface.

4. The data processing method according to claim 3, wherein sequentially caching the plurality of data packets in the first data to the data forwarding queue through the enqueue interface comprises:
sequentially performing following operations on each data packet of the plurality of data packets in the first data:
receiving the data packet through the enqueue interface;
determining whether a total amount of data in the data forwarding queue is greater than or equal to a third preset threshold;
in a case where the total amount of data in the data forwarding queue is greater than or equal to the third preset threshold, discarding the data packet; and
in a case where the total amount of data in the data forwarding queue is not greater than or equal to the third preset threshold, inserting the data packet into a tail of the data forwarding queue.

5. The data processing method according to claim 3, wherein after sequentially caching the plurality of data packets in the first data to the data forwarding queue through the enqueue interface, the data processing method further comprises:
invoking a dequeue interface of the data forwarding queue through the second central processor; and
triggering the data forwarding interrupt through the second central processor in a case where there is at least one data packet in the data forwarding queue.

6. The data processing method according to claim 5, wherein after triggering the data forwarding interrupt through the second central processor, the data processing method further comprises:
invoking, through the second central processor, an interrupt service function bound with the data forwarding interrupt; and
invoking a tasklet function through the interrupt service function, wherein the tasklet function is put into a tasklet task queue, and is sequentially scheduled and executed by the second central processor.

7. The data processing method according to claim 5, wherein extracting the second data from the data forwarding queue, and performing the second-stage data processing on the second data through the second central processor comprises:
sequentially extracting all data packets in the data forwarding queue from a head of the data forwarding queue, so as to obtain the second data;
invoking a pre-encapsulated callback function through the second central processor; and
performing the second-stage data processing on the second data through the pre-encapsulated callback function.

8. The data processing method according to claim 1, wherein
the data to be processed comprises data in a transport direction that is acquired from a wired side interface and data in a reception direction that is acquired from a wireless side interface;
the data forwarding queue comprises a queue in the transport direction and a queue in the reception direction;
each data forwarding queue corresponds to one enqueue interface and one dequeue interface respectively; and
the data forwarding queue is a lockable queue, and each data forwarding queue is able to invoke only one of the enqueue interface or the dequeue interface at the same time.

9. The data processing method according to claim 8, wherein performing, through the first central processor, the first-stage data processing on the data to be processed comprises:
in a case where the data to be processed is the data in the transport direction, transporting the data in the transport direction from the wired side interface to a WiFi driver through an Internal Direct Memory Access (IDM) driver, wherein the wired side interface comprises a Passive Optical Network (PON) interface, a Wide Area Network (WAN) interface or a Local Area Network (LAN) interface; or,
in a case where the data to be processed is the data in the reception direction, performing data processing on the data in the reception direction through closed-source software in the WiFi driver.

10. The data processing method according to claim 9, wherein performing the second-stage data processing on the second data through the second central processor comprises:
in a case where the data to be processed is the data in the transport direction, performing data processing on the second data in the transport direction through open-source software in the WiFi driver, so as to obtain third data; or,
in a case where the data to be processed is the data in the reception direction, performing data processing on the second data in the reception direction through open-source software in the WiFi driver, so as to obtain third data.

11. The data processing method according to claim 10, wherein after performing the data processing on the second data in the transport direction through the open-source software in the WiFi driver, so as to obtain the third data, the data processing method further comprises:
triggering a second interrupt through the first central processor;
performing third-stage data processing on the third data through the first central processor, so as to obtain fourth data, wherein performing the third-stage data processing on the third data comprises: performing data processing on the third data through closed-source software in the WiFi driver; and
transporting the fourth data through the wireless side interface.

12. The data processing method according to claim 10, wherein after performing the data processing on the second data in the reception direction through the open-source software in the WiFi driver, so as to obtain the third data, the data processing method further comprises:
transporting the third data from the WiFi driver to the wired side interface through the IDM driver; and
transporting the third data through the wired side interface.

13. The data processing method according to claim 9, wherein before performing, through the first central processor, the first-stage data processing on the data to be processed, the data processing method further comprises:
during an initialization phase of the WiFi chip, pre-applying for a memory pool for the IDM driver and the WiFi driver, wherein the memory pool stores data packets of the IDM driver or the WiFi driver in a memory space in a stack mode.

14. The data processing method according to claim 13, wherein the data processing method further comprises:
in a case where the IDM driver or the WiFi driver receives the data packet, popping a memory space corresponding to the data packet from a top of the memory pool, wherein the memory space is used for storing the data packet;
in a case where the IDM driver or the WiFi driver releases the data packet, pushing a memory space corresponding to the data packet from the top of the memory pool.

15. The data processing method according to claim 1, wherein before performing, through the first central processor, the first-stage data processing on the data to be processed, the data processing method further comprises:
during an initialization phase of the WiFi chip, binding the first interrupt and the second interrupt to the first central processor; and
binding the data forwarding interrupt to the second central processor.

16. (canceled)

17. A non-transitory computer-readable storage medium, wherein the computer-readable storage medium stores a computer program, wherein the computer program, when running by a processor, causes the processor to execute operations comprising:
performing, through a first central processor, first-stage data processing on data to be processed, so as to obtain first data;
in a case where the first central processor triggers a first interrupt, caching the first data to a data forwarding queue; and
in a case where a second central processor triggers a data forwarding interrupt, extracting second data from the data forwarding queue, and performing second-stage data processing on the second data through the second central processor, wherein the second data is part or all of data in the first data.

18. An electronic device, comprising a memory and a processor, wherein the memory stores a computer program, and the processor is configured to run the computer program so as to execute operations comprising:
performing, through a first central processor, first-stage data processing on data to be processed, so as to obtain first data;
in a case where the first central processor triggers a first interrupt, caching the first data to a data forwarding queue; and
in a case where a second central processor triggers a data forwarding interrupt, extracting second data from the data forwarding queue, and performing second-stage data processing on the second data through the second central processor, wherein the second data is part or all of data in the first data.

19. The data processing method according to claim 1, wherein the data forwarding queue is encapsulated as a closed-source Wireless Forward Module (WFWD).

20. The data processing method according to claim 4, wherein the third preset threshold is equal to a number of data packets that the data forwarding queue is able to accommodate, and the third preset threshold is adjusted based on a size of a pre-applied memory space.

21. The data processing method according to claim 1, wherein the data processing method is applied to multi-core CPUs, by triggering interrupts to divide a complete data processing procedure into an arbitrary number of stages, and then processing the data packets separately in multiple cores through data forwarding interrupts.
